(19) United States
(12) Patent Application Publication
(10) Pub. No.: US 2012/0027107 A1
(43) Pub. Date: Feb. 2, 2012

(54) COMMUNICATION DEVICE AND COMMUNICATION METHOD IN DATA TRANSMISSION SYSTEM

(76) Inventor: TSUGIO TAKAHASHI, Tokyo (JP)

(21) Appl. No.: 13/195,597

(22) Filed: Aug. 1, 2011

(30) Foreign Application Priority Data
Aug. 2, 2010 (JP) 2010-173482

(51) Int. Cl. H04L 27/00

(52) U.S. Cl. 375/259; 375/295

(57) ABSTRACT

A communication device includes: a detector for detecting a predetermined number of consecutive identical codes from first data for transmission to generate a bit inversion instruction signal; a data inversion section for inversing at least one bit of the first data when the bit inversion instruction signal is generated; and a transmitter for transmitting the second data to another communication device. The predetermined number is not greater than a specified number of consecutive identical codes in the data transmission system.

This application is based upon and claims the benefit of priority from Japanese Patent Application No. 2010-173482, filed on Aug. 2, 2010, the disclosure of which is incorporated herein in its entirety by reference.

### BACKGROUND OF THE INVENTION

1. Field of the Invention

The present invention relates to a data transmission system and, more particularly, to a communication device and a communication method in a data transmission system having a permissible value of immunity against consecutive identical codes.

2. Description of the Related Art

In a data transmission system provided with clock data recovery (CDR) functionality on a receiving side, accurate clock cannot be recovered if identical codes consecutively follow for a predetermined period of time or longer in data received from a sending side. As a result, data cannot be reproduced, leading to the possibility of burst error occurrence. To avoid this situation, various means for preventing identical codes from consecutively occurring are proposed, of which two broad methods are well known.

One is a method in which a bit rate is increased and redundant bits are inserted. The insertion of redundant bits can certainly suppress consecutive identical codes. For example, Japanese Patent Application Unexamined Publication No. H9-214565 discloses a data transmission device that performs transmission after adding an inversed bit when identical codes consecutively occur.

The other one is a method of performing scrambling on data. That is, scrambling is performed on transmission data, thereby reducing the probability of identical codes consecutively occurring. In synchronous network (SONET/SDH) employing this scrambling-type method, it is defined that consecutive identical codes should be 72 bits or less. However, it is known that consecutive identical codes may be contained even in such a scrambled signal (see Japanese Patent Application Unexamined Publication No. 2001-197043).

However, according to the above-described redundant bit insertion method, the bit rate of a system needs to be increased. Further, there is a problem that complicated coding functionality and decoding functionality are required on the sending and receiving sides for bit insertion and deletion processing and the like.

Moreover, the method of performing scrambling is statistical means and, as well known, cannot certainly eliminate the possibility of consecutive identical codes following. For example, in SONET/SDH, there are some cases where 72 bits or more of identical codes consecutively occur with a certain probability. As in such cases, when identical codes consecutively occur exceeding a CDR section's immunity against consecutive identical codes in a synchronous network, the effect is not only a burst error of data but also can extend to a loss of frame synchronization and the like (see FIG. 11). If a loss of frame synchronization happens, the influence is significant because data transfer is stopped for a period of several frames until synchronization is pulled in again. To eliminate such influence, a sufficient margin is generally provided to the characteristic of immunity against consecutive identical codes, which is required of a CDR section (see a comparative example in FIG. 2B). However, the provision of a CDR section having a sufficient margin of the immunity against consecutive identical codes makes it difficult to lower the price of a receiver.

Moreover, in a system provided with forward error correction (FEC) functionality, errors can be corrected to some degree, but it is difficult in many cases to accomplish certain error correction to those errors that last for a long period of time like a burst error caused by CUR malfunction.

To sum up, the method of performing scrambling on data has the possibility that a predetermined number of bits or more of identical codes consecutively follow, in which case a CDR section will operate abnormally, resulting in a burst error occurring in received data. If a circuit with excellent immunity against consecutive identical codes is employed to avoid this happening, circuitry will be complicated, and it will be difficult to lower the price thereof.

### SUMMARY OF THE INVENTION

Accordingly, an object of the present invention is to provide a communication device and a communication method in a highly reliable data transmission system in which clock can be certainly recovered even if identical codes consecutively follow, without complicating the configuration and functionality of the system.

A communication device according to the present invention is a communication device in a data transmission system, includes: a detector for detecting a predetermined number of consecutive identical codes from first data for transmission to generate a bit inversion instruction signal; a data inversion section for inversing at least one bit of the first data when the bit inversion instruction signal is generated; and a transmitter for transmitting the second data to another communication device, wherein the predetermined number is not greater than a specified number of consecutive identical codes in the data transmission system.

A communication method according to the present invention is a communication method of a sending-side communication device in a data transmission system, includes the steps of: detecting a predetermined number of consecutive identical codes from first data for transmission to generate a bit inversion instruction signal; inverting at least one bit of the first data when the bit inversion instruction signal is generated; and transmitting the second data to a receiving-side communication device, wherein the predetermined number is not greater than a specified number of consecutive identical codes in the data transmission system.

A data transmission system according to the present invention is a data transmission system in which a sending-side communication device sends data to a receiving-side communication device, wherein the sending-side communication device includes: a detector for detecting a predetermined number of consecutive identical codes from first data for transmission to generate a bit inversion instruction signal, wherein the predetermined number is not greater than a specified number of consecutive identical codes in the data transmission system; a data inversion section for inversing at least one bit of the first data when the bit inversion instruction signal is generated; and a transmitter for transmitting the second data to the receiving-side communication device, and the receiving-side communication device includes: a receiver for receiving the second data from the sending-side communication device; and a clock recovery section for recovering a clock from the second data, wherein immunity against consecutive identical codes of the clock recovery section is not greater than the specified number of consecutive identical codes in the data transmission system.

According to the present invention, it is possible to achieve a highly reliable data transmission system in which clock can be certainly recovered even if identical codes consecutively follow, without complicating the configuration and functionality of the system.

### BRIEF DESCRIPTION OF THE DRAWINGS

FIG. 1 is a schematic system configuration diagram showing a data transmission system according to an exemplary embodiment of the present invention.

FIG. 2A is a signal waveform diagram for describing a data transmission method in the data transmission system shown in FIG. 1.

FIG. 2B is a schematic diagram in which a comparison of immunity against consecutive identical codes to be set on a clock recovery section is made between when an inversed bit according to a present example is provided and when no inversed bit is provided.

FIG. 3 is a system configuration diagram showing a data transmission system according to a first example of the present invention.

FIG. 4A is a functional block diagram for describing the operation of a data inversion section in FIG. 3.

FIG. 4B is a truth table for describing an operation function of the data inversion section.

FIG. 5 is a signal waveform diagram for describing a data transmission method according to the first example.

FIG. 6 is a system configuration diagram showing a data transmission system according to a second example of the present invention.

FIG. 7 is a signal waveform diagram for describing a data transmission method according to the second example.

FIG. 8 is a signal waveform diagram for describing a data transmission method according to a third example of the present invention.

FIG. 9 is a signal waveform diagram for describing a data transmission method according to a fourth example of the present invention.

FIG. 10A is a signal waveform diagram for describing a data transmission method according to a fifth example of the present invention.

FIG. 10B is a signal waveform diagram for describing a data transmission method according to a modification example of the fifth example.

FIG. 11 is a signal waveform diagram for describing, as a comparative example, a data transmission method that does not employ the present invention.

### DETAILED DESCRIPTION OF THE PREFERRED EMBODIMENTS

### 1. First Exemplary Embodiment

### 1.1) Configuration

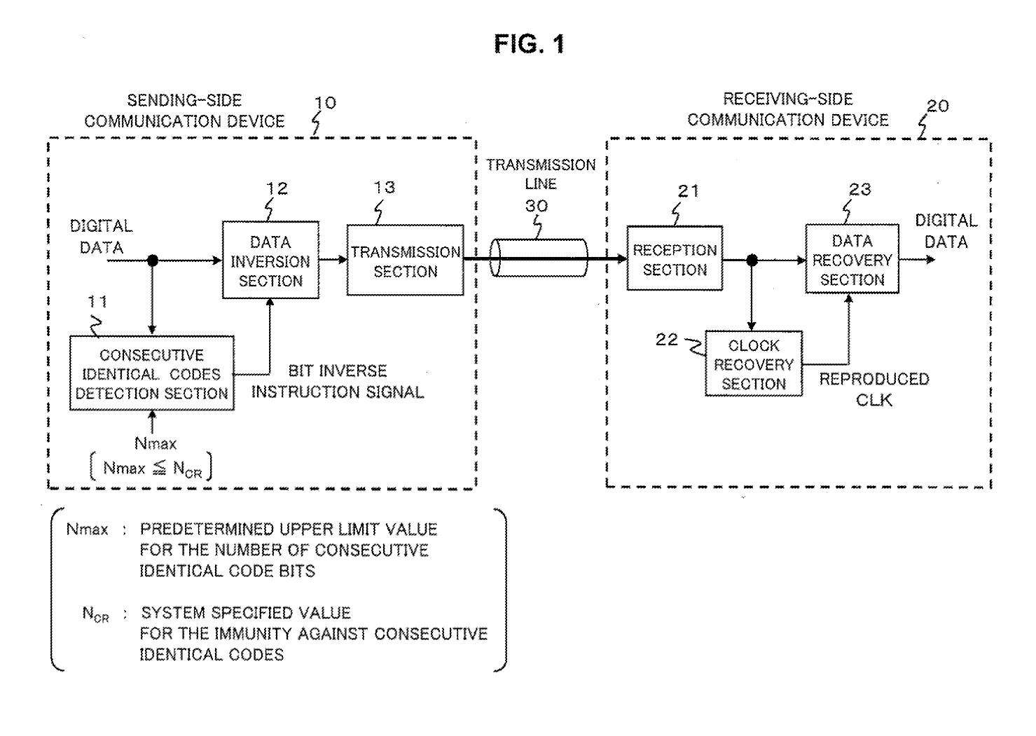

Referring to FIG. 1, in a data transmission system according to an exemplary embodiment of the present invention, it is assumed that a sending-side communication device 10 and a receiving-side communication device 20 are connected through a transmission line 30. The sending-side communication device 10 is provided with a consecutive identical codes detection section 11, a data inversion section 12, and a transmission section 13. The receiving-side communication device 20 is provided with a reception section 21, a clock recovery section 22, and a data recovery section 23. In this data transmission system, it is assumed that a specified permissible value (system specified value) for the number of consecutive identical code bits is predetermined to be N_{CR} bits.

The consecutive identical codes detection section 11 outputs a bit inverse instruction signal to the data inversion section 12 when it detects that a predetermined number of identical codes or more consecutively occur in digital data for transmission. The data inversion section 12 receives as an input the digital data for transmission and, if receiving no bit inverse instruction signal, passes the input digital data as it is to the transmission section 13 as transmission data. When receiving a bit inverse instruction signal, the data inversion section 12 inverses a bit value at the timing of the bit inverse instruction signal in the input digital data. Thus, the data inversion section 12 outputs data containing the inversed bit (that is, an error bit) to the transmission section 13 as transmission data. The data sent out from the transmission section 13 arrives at the reception section 21 of the receiving-side communication device 20 through the transmission line 30.

The clock recovery section 22 of the receiving-side communication device 20 reproduces a clock from the data received by the reception section 21 and outputs the reproduced clock CLK to the data recovery section 23. The data recovery section 23 retimes the data received by the reception section 21 in accordance with the reproduced clock CLK and recovers digital data.

Here, in the receiving-side communication device 20, data is only recovered by the data recovery section 23. Therefore, the recovered data may contain the inversed bit attributable to the fact that consecutive identical codes are detected on the sending side. Although this inversed bit is an error bit as mentioned above, the error is as little as is masked by communication channel error rate through the transmission line 30 and has no practical influence on operation.

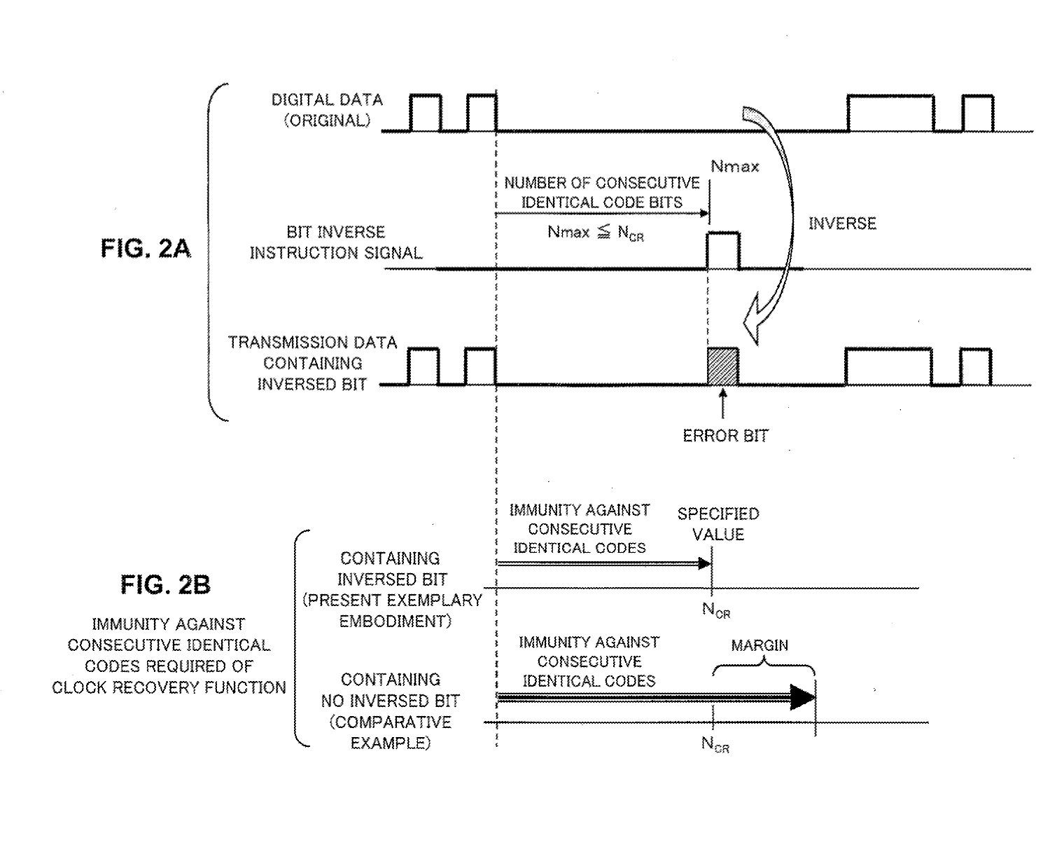

On the other hand, the existence of an inversed bit that sets an upper limit of the number of consecutive identical code bits is required to realize reliable clock recovery on the receiving side. According to the present exemplary embodiment, the bit inverse instruction timing, which is set by the consecutive identical codes detection section 11 on the sending side, is set for the system specified value N_{CR} or less, whereby it is possible to achieve accurate clock recovery even if the immunity against consecutive identical codes of the receiving-side is not greater than the system specified value N_{CR}. Hereinafter, basic operation of the consecutive identical codes detection section 11 will be described with reference to FIGS. 2A and 2B.

### 1.2) Operation

Referring to FIG. 2A, the consecutive identical codes detection section 11 receives as an input digital data for transmission and counts consecutive identical code bits. When the number of consecutive identical code bits reaches a predetermined upper limit value Nₘₐₓ, the consecutive identical codes detection section 11 outputs a bit inverse instruction signal to the data inversion section 12 and then resets a counter. The data inversion section 12 passes the input digital data as it is to the transmission section 13 as transmission data when receiving no bit inverse instruction signal. However, when receiving a bit inverse instruction signal as an input, the data inversion section 12 inverses the value of a corresponding bit at the timing of the bit inverse instruction signal and outputs the data containing the inversed bit (an error bit) as transmission data to the transmission section 13.

The predetermined upper limit value Nₘₐₓ for the number of consecutive identical code bits is set for a value not higher than the system specified value N_{CR}. Thereby, the receiving-side clock recovery section 22 receives an inversed bit without fail before the number of consecutive identical code bits in the received signal exceeds the specified value N_{CR}. If identical codes further consecutively occur, the consecutive identical codes detection section 11 outputs a bit inverse instruction signal each time the number of consecutive identical code bits reaches the predetermined upper limit value Nₘₐₓ. Accordingly, according to the present exemplary embodiment, it is possible to maintain reliable clock recovery even if the immunity against consecutive identical codes of the clock recovery section 22 is not greater than the specified value N_{CR}, as shown in FIG. 2B. It is not necessary to provide a margin on the assumption that the number of consecutive identical code bits may exceed the specified value N_{CR} as in a comparative example in FIG. 2B.

Note that since it is sufficient that the predetermined upper limit value Nₘₐₓ of the consecutive identical codes detection section 11 is set no higher than the specified value N_{CR}, the consecutive identical codes detection section 11 may also inverse a plurality of bits. Moreover, if the predetermined upper limit value Nₘₐₓ is set no higher than half of the specified value N_{CR}, it is possible to allow an inversed bit to repeat at constant intervals during a period of the specified value N_{CR}. Furthermore, if the predetermined upper limit value Nₘₐₓ of the consecutive identical codes detection section 11 is configured to be variably set, it is possible to set an inversed bit pattern with desired cycle within a range in which error correction processing for the communication channel is not affected.

In addition, although not shown in FIG. 1, each of the sending-side communication device 10 and receiving-side communication device 20 is provided with a program-controlled processor such as a central processing unit (CPU) and a recording medium for storing programs. The functions of the consecutive identical codes detection section 11 and data inversion section 12 on the sending side and the CDR function of the clock recovery section 22 and data recovery section 23 on the receiving side can also be implemented by executing programs on the respective program-controlled processers.

### 1.3) Effects

As described above, according to the present exemplary embodiment, on a digital data sending side, if identical codes consecutively occur, part of data in a specified section of the consecutive identical codes is inversed. Therefore, it is possible to suppress the number of consecutive identical code bits below a specified value. Accordingly, the occurrence of a burst error can be certainly prevented without providing a receiving-side CDR section with a margin exceeding the specified value of immunity against consecutive identical codes.

In other words, since the immunity against consecutive identical codes of the CDR section does not need to have a margin not smaller than the specified value, it is not necessary to increase the performance of the CDR functionality, which makes it possible to further lower price. Moreover, it is also possible to adapt to the immunity against consecutive identical codes of the receiving-side CDR functionality by adjusting the predetermined upper limit value Nₘₐₓ to be set on the sending-side consecutive identical codes detection section.

Nevertheless, as mentioned above, the inversion of data, which only causes the inversed bit to be recognized as data error at a receiver, is not practically a problem if the data error is as little as is masked by communication channel error rate. Additionally, in a system provided with forward error correction (FEC) functionality, error-free transfer is possible in the end because an error inserted on the sending side is automatically corrected on the receiving side.

### 2. First Example

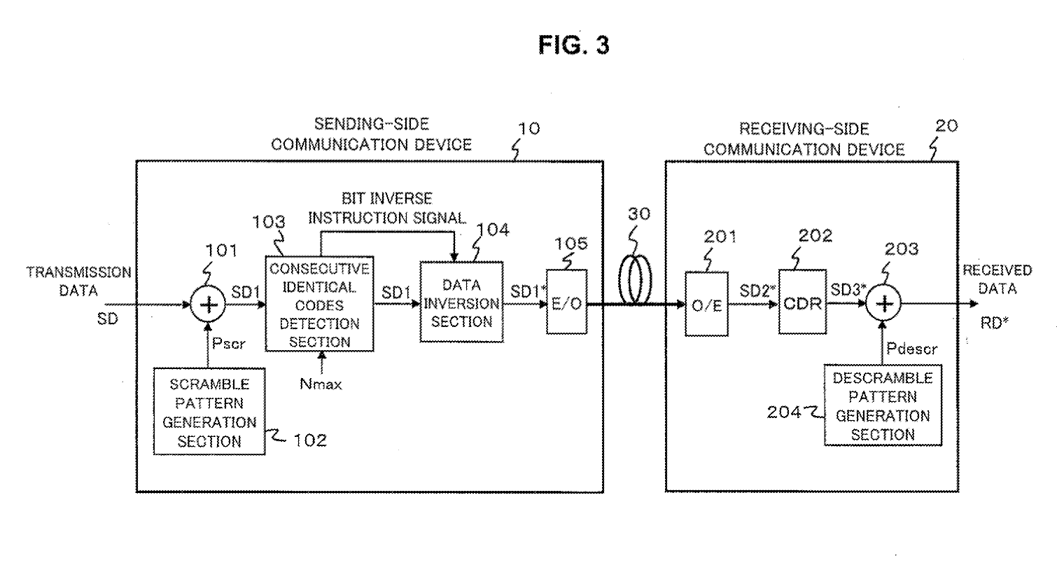

Referring to FIG. 3, in a data transmission system according to a first example of the present invention, it is assumed that a sending-side communication device 10 and a receiving-side communication device 20 are connected through a fiber-optic transmission line 30 and that N_{CR} is a predetermined maximum value (specified value) for the number of consecutive identical code bits.

The sending-side communication device 10 includes a scrambler 101 that performs scrambling on transmission data SD by using a scramble pattern P_{scr} and outputs scrambled data SD1. The scramble pattern P_{scr} is generated by a scramble pattern generation section 102. As mentioned above, the scrambled data SD1 obtained after scrambling may also contain consecutive identical codes. A consecutive identical codes detection section 103, a data inversion section 104, and an electrical/optical conversion section 105 correspond to the consecutive identical codes detection section 11, data inversion section 12, and transmission section 13 in FIG. 1, respectively.

The consecutive identical codes detection section 103 receives as an input the scrambled data SD1, counts consecutive identical code bits, and determines whether or not the count value reaches a predetermined upper limit value Nₘₐₓ. When the number of consecutive identical code bits reaches the predetermined upper limit value Nₘₐₓ, the consecutive identical codes detection section 103 outputs a bit inverse instruction signal to the data inversion section 104 and then resets a counter.

The data inversion section 104 receives as an input the scrambled data SD1 and, when no bit inverse instruction signal is generated, passes the scrambled data SD1 as it is to the electrical/optical conversion section 105. When a bit inversion instruction signal is input, the data inversion section 104 inverses the value of a corresponding bit at the timing of the bit inverse instruction signal and outputs the data containing the inversed bit (an error bit) to the electrical/optical conversion section 105. The transmission data to be output from the data inversion section 104, which may contain the inversed bit, will be hereinafter denoted by SD1*.

The receiving-side communication device 20 includes an optical/electrical conversion section 201 and a CDR section 202. The optical/electrical conversion section 201 corresponds to the reception section 21 in FIG. 1, and the CDR section 202 corresponds to the clock recovery section 22 and data recovery section 23 in FIG. 1. The receiving-side communication device 20 further includes a descrambler 203 and a descramble pattern generation section 204.

Received data SD2* output from the optical/electrical conversion section 201 is input to the CDR section 202, where clock and data recovery is performed as described above, and recovered data SD3* is output to the descrambler 203. The descramble pattern generation section 204 generates a descramble pattern P_{descr} corresponding to the scramble pattern P_{scr} on the sending side. Therefore, the descrambler 203 uses the descramble pattern P_{descr} to descramble the recovered data SD3* and then outputs received data RD*. As described above, since performed at the receiving-side communication device 20 is only data recovery by the CDR section 202 and descrambling by the descrambler 203, the received data RD* may contain an inversed bit. However, this inversed bit is as little as is masked by communication channel error rate through the optical fiber transmission line 30 and therefore has no practical influence on operation.

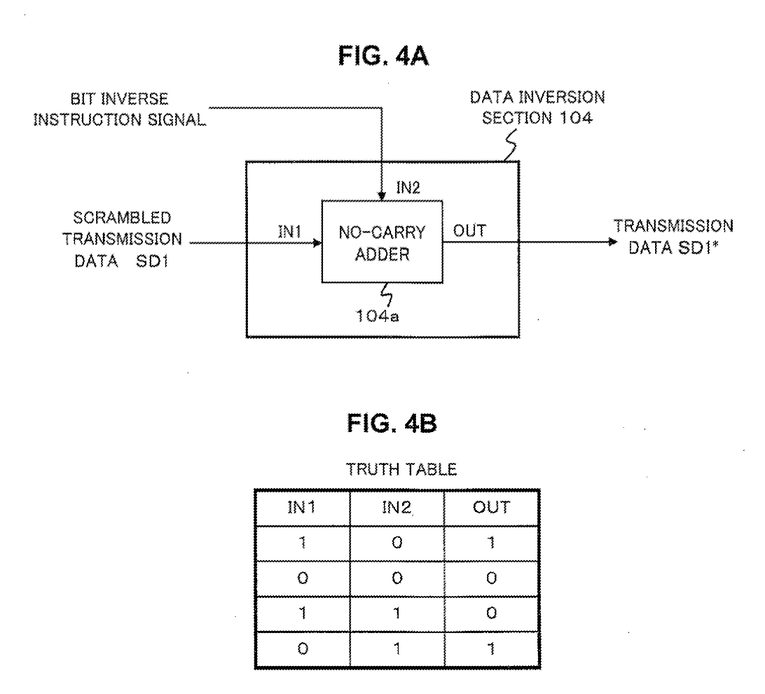

Referring to FIG. 4A, the data inversion section 104 can be configured using a no-carry adder 104a. The scrambled data SD1 is input to an input IN1 of the adder 104a, and the bit inverse instruction signal is input to an input IN2 of the adder 104a. As a result, the transmission data SD1* is output from an output OUT of the adder 104a.

Logical operation performed by the adder 104a can be represented by a truth table shown in FIG. 4B. As seen from this truth table, the adder 104a inverses the scrambled data SD1 only when the bit inverse instruction signal input to the input IN2 is “1”. When the bit inverse instruction signal is “0”, the scrambled data SD1 passes through.

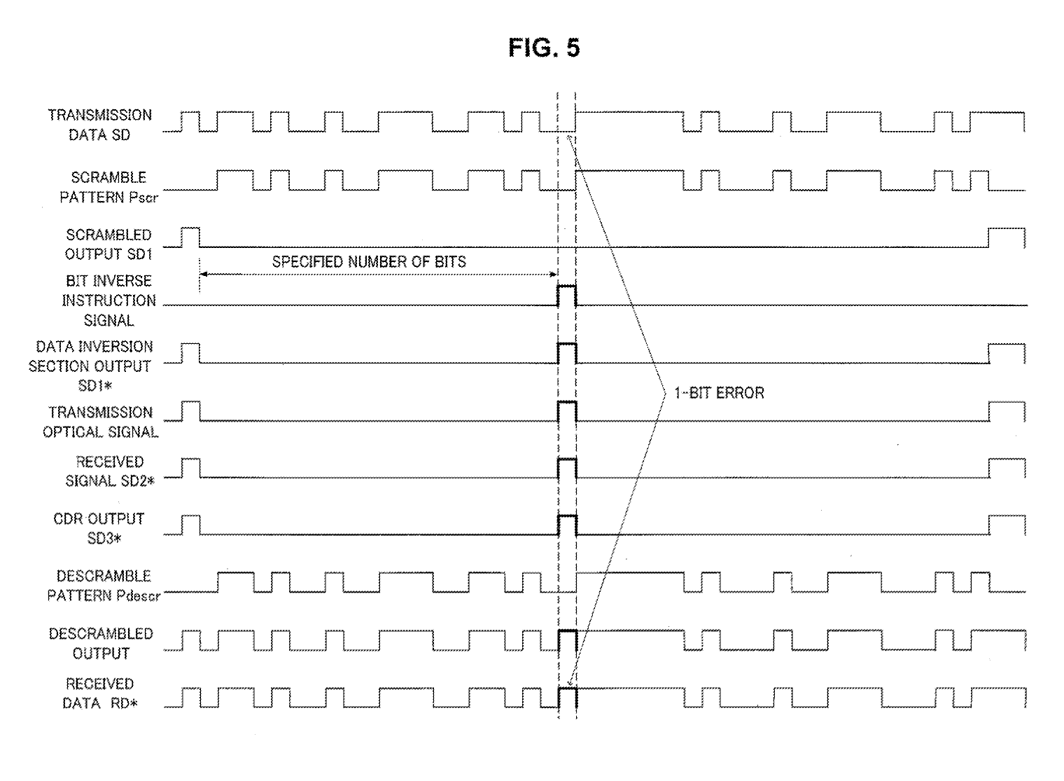

Referring to FIG. 5, it is assumed that when scrambling is performed on the transmission data SD by using the scramble pattern P_{scr}, the scrambled output SD1 is a series of consecutive identical codes. In this case, when the number of consecutive identical codes reaches the predetermined upper limit value Nₘₐₓ, the consecutive identical codes detection section 103 outputs a bit inverse instruction signal, whereby the data inversion section 104 outputs the output SD1* in which the value of a corresponding bit is inversed. This data SD1* is transmitted and, at the receiving-side communication device 20, input to the CDR section 202 as the data SD2*.

Since the data SD2* has no more than the specified number N_{CR} of consecutive identical code bits, the CDR section 202 can accurately recover clock and data. The recovered data SD3* is descrambled by the descrambler 203, whereby the received data RD* is obtained. This received data RD* contains the bit corresponding to the bit inverse instruction signal as an error bit.

According to the present example, although a one-bit error occurs because data transmission is performed with the consecutiveness of identical codes being suppressed, it is possible to prevent a burst error from occurring at the receiving-side CDR section 202, and it is accordingly possible to prevent a loss of frame synchronization and the like caused by the burst error. Since a loss of frame synchronization can be prevented, long-period interruption of data communication can be avoided.

Moreover, according to the present example, it is not necessary to provide a margin to make the immunity against consecutive identical codes of the CDR section 202 greater than the specified value. Accordingly, it is not necessary to enhance the performance of the CDR functionality, and it is therefore possible to facilitate lower costs. On the contrary, the immunity against consecutive identical codes of the receiving-side CDR functionality can be determined by adjusting the predetermined upper limit value Nₘₐₓ to be set on the sending-side consecutive identical codes detection section 103, and accordingly the flexibility in system design is greatly increased.

### 3. Second Example

It is possible to further add a forward error correction (FEC) function to the above-described data transmission system of the first example.

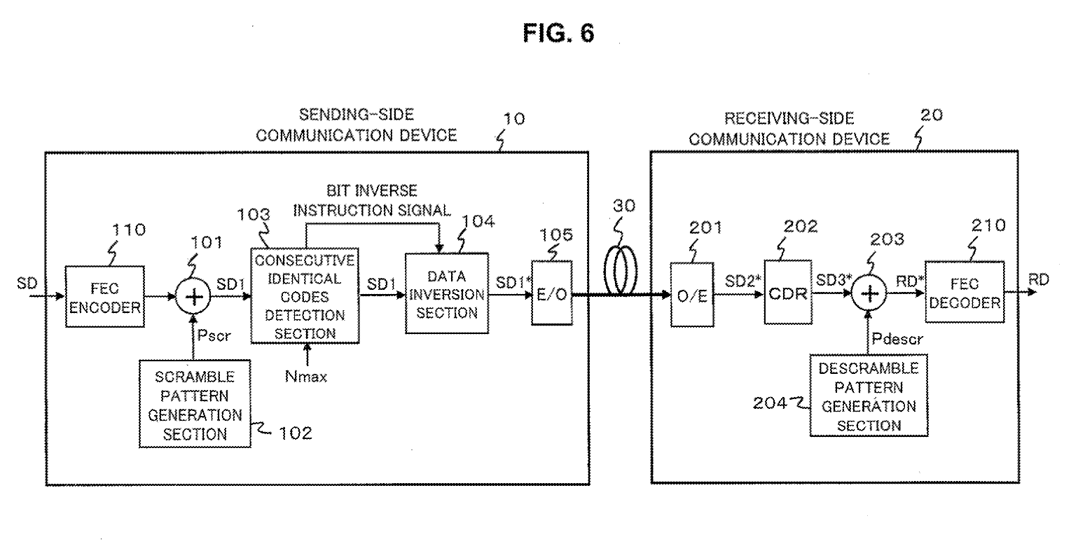

Referring to FIG. 6, a FEC encoder 110 is provided to the sending-side communication device 10, placed prior to the scrambler 101, and a FEC decoder 210 is provided to the receiving-side communication device 20, placed subsequent to the descrambler 203. The other configuration and operation are similar to those of the first example, and therefore a description thereof will be omitted with the same reference numerals as in the first example given to the corresponding sections.

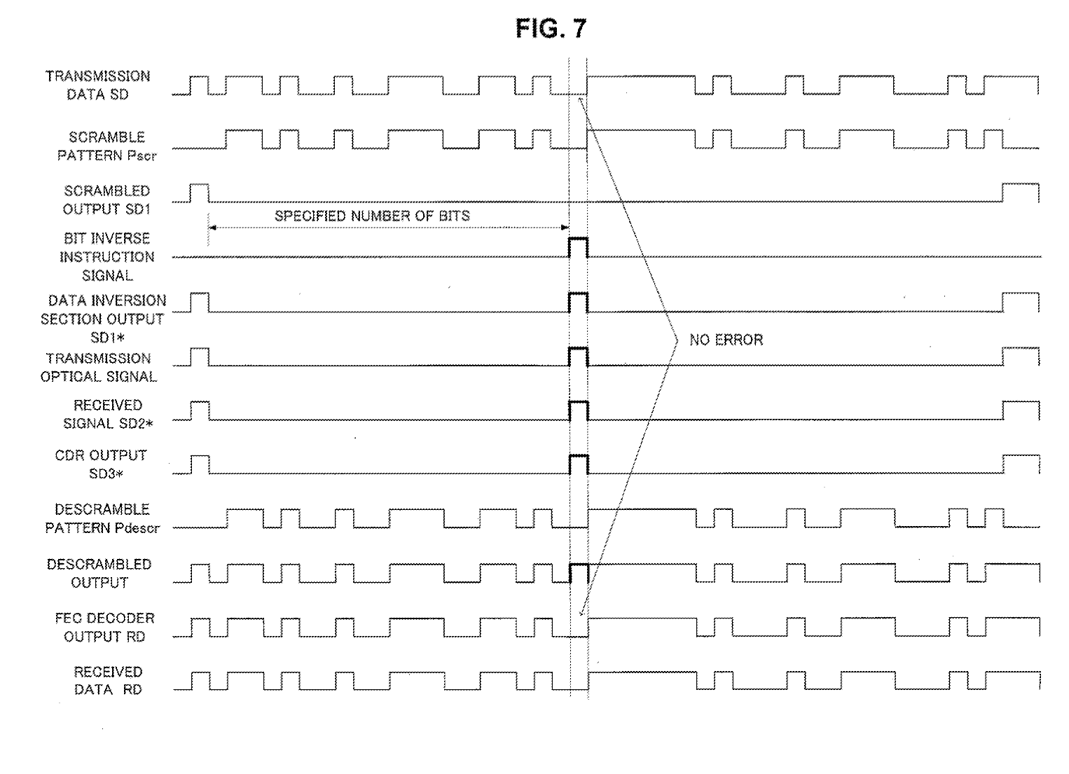

The addition of this FEC function allows an inversed bit (error bit), which is inversed by the data inversion section 104, to go through error correction performed by the receiving-side FEC decoder 210. As a result, it is possible to obtain received data RD having no error, as shown in FIG. 7.

### 4. Third Example

The number of bits to be inversed is not limited to one as in the above-described examples.

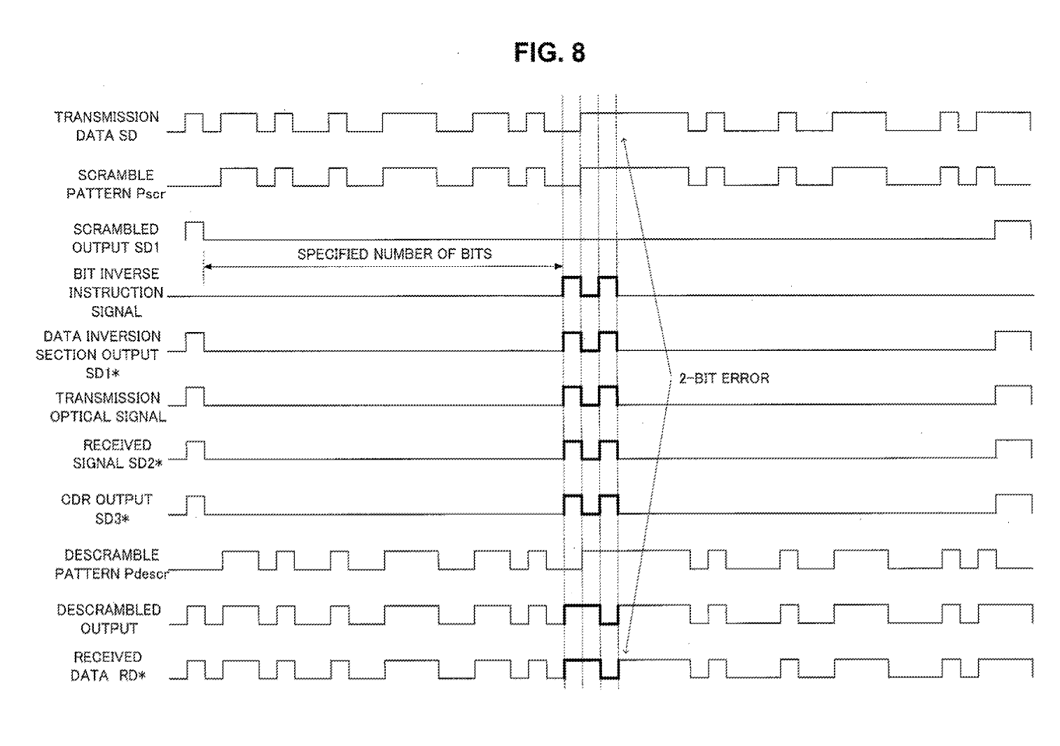

Referring to FIG. 8, the number of bits inserted to avoid identical codes consecutively following can also be two or larger. In a system provided with no FEC function, although the number of bit errors is increased on the receiving side, it is possible to more certainly suppress CDR abnormal operation on the receiver side due to the effect of consecutive identical codes.

### 5. Fourth Example

The inversion of bits is also applicable to a one-byte section. This is particularly favorable to a case where FEC capable of byte-by-byte error correction is applied.

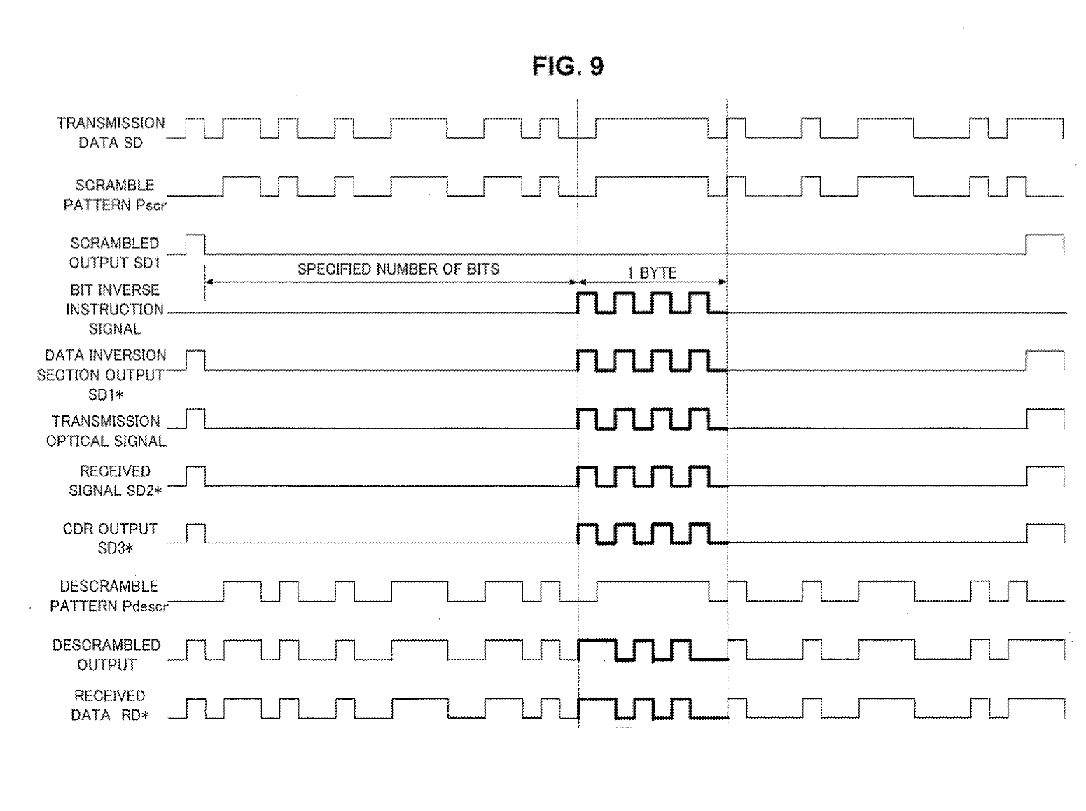

Referring to FIG. 9, in a case where FEC capable of byte-by-byte error correction is applied, abnormal operation of the CDR section 202 can be more certainly suppressed by allowing inversed bits to be one byte. Additionally, the inversed byte can be certainly error-corrected by FEC. FIG. 9 shows an example of correction patterns. However, in a case where one byte=eight bits, any one of 255 patterns ranging from “00000001” to “11111111” can be applied.

It is needless to say that the number of bytes inversed is not limited to one and may be two or larger.

### 6. Fifth Example

An inverted bit or inverted bits can be set at any desired place (timing) by using the predetermined upper limit value Nₘₐₓ of the consecutive identical codes detection section 103.

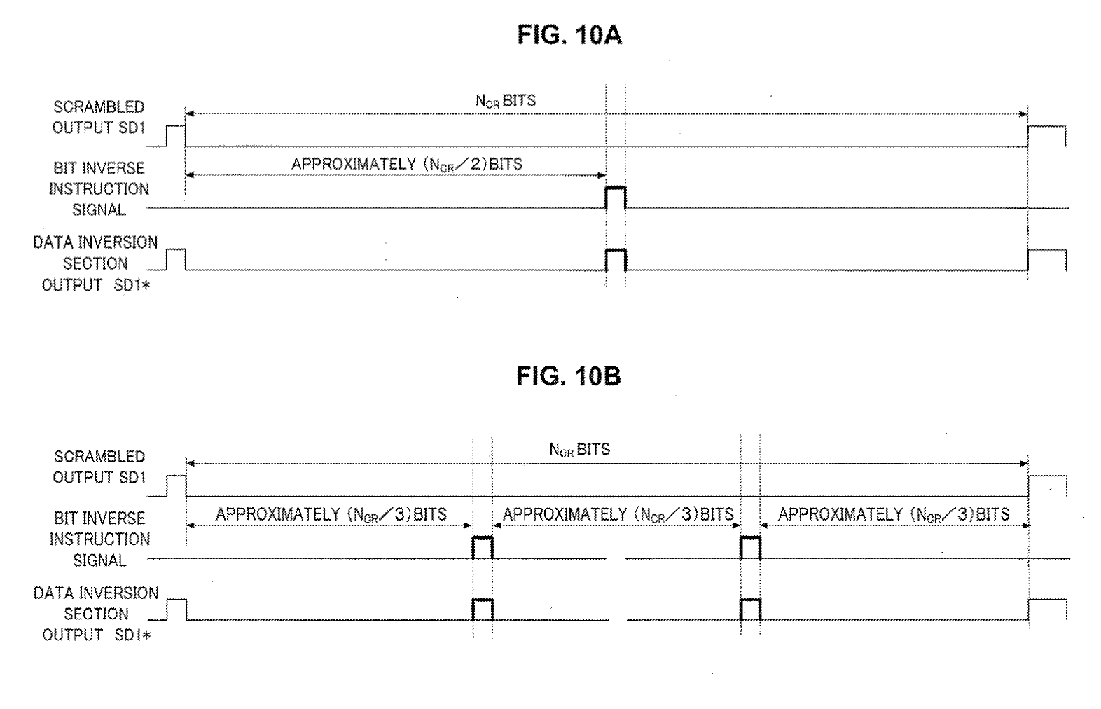

An inversed bit can be set at a timing equivalent to half the specified number of bits by setting the predetermined upper limit value Nₘₐₓ at about half the specified value N_{CR} for the number of consecutive identical codes, as shown in FIG. 10A. Moreover, if Nₘₐₓ=N_{CR}/3 as shown in FIG. 10B, two inverted bits can be set at timings equivalent to ⅓ and ⅔ of the specified number of bits. In general, any desired timing for bit inversion can be set to 1/n, 2/n, . . . (n−1)/n of the specified number of bits, where n is a predetermined integer greater than one (1).

### 7. Comparative Example

As described in the above individual examples, an inversed bit is set at a timing of no greater than the specified value N_{CR}, whereby it is guaranteed that clock and data are certainly recovered by CDR on the receiving side.

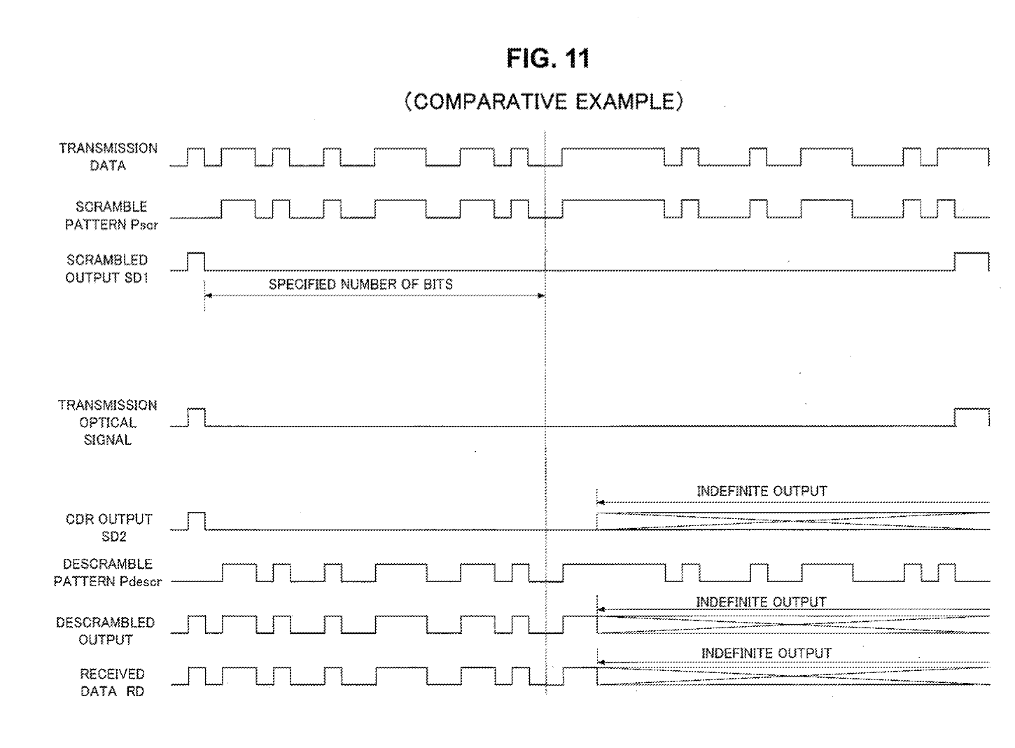

On the other hand, if an inversed bit made by the above-described consecutive identical codes detection section 103 and data inversion section 104 is not used, the scrambled output SD1 is a sequence of consecutive identical codes as shown in FIG. 11. When the number of consecutive identical codes exceeds the system specified number N_{CR} of bits, the receiving-side CDR abnormally operates, resulting in a burst error occurring. According to the present invention, such abnormal operation of the receiving-side CDR can be certainly prevented.

The present invention can be applied to a data transmission system having on a receiving side the CDR functionality of recovering clock from received data, as well as to communication devices in the system.

The present invention may be embodied in other specific forms without departing from the spirit or essential characteristics thereof. The above-described exemplary embodiment and examples are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A communication device in a data transmission system, comprising:
a detector for detecting a predetermined number of consecutive identical codes from first data for transmission to generate a bit inversion instruction signal;
a data inversion section for inversing at least one bit of the first data when the bit inversion instruction signal is generated; and
a transmitter for transmitting the second data to another communication device,
wherein the predetermined number is not greater than a specified number of consecutive identical codes in the data transmission system.

2. The communication device according to claim 1, further comprising a scrambling section for scrambling transmission data to generate the first data.

3. The communication device according to claim 2, further comprising an encoder for encoding original transmission data according to error-correction coding to generate the transmission data.

4. The communication device according to claim 1, wherein the data inversion section inverts each bit of one byte of the first data.

5. The communication device according to claim 1, wherein the specified number is a value specified for immunity against consecutive identical codes required of clock recovery.

6. The communication device according to claim 1, wherein the predetermined number is determined by dividing the specified number by a desired integer greater than one.

7. A communication method of a sending-side communication device in a data transmission system, comprising:
detecting a predetermined number of consecutive identical codes from first data for transmission to generate a bit inversion instruction signal;
inverting at least one bit of the first data when the bit inversion instruction signal is generated; and
transmitting the second data to a receiving-side communication device,
wherein the predetermined number is not greater than a specified number of consecutive identical codes in the data transmission system.

8. The communication method according to claim 7, further comprising: scrambling transmission data to generate the first data.

9. The communication method according to claim 8, further comprising: encoding original transmission data according to error-correction coding to generate the transmission data.

10. The communication method according to claim 7, wherein each bit of one byte of the first data is inverted.

11. The communication method according to claim 7, wherein the specified number is a value specified for immunity against consecutive identical codes required of clock recovery.

12. The communication method according to claim 7, wherein the predetermined number is determined by dividing the specified number by a desired integer greater than one.

13. A data transmission system in which a sending-side communication device sends data to a receiving-side communication device, wherein
the sending-side communication device comprises:
a detector for detecting a predetermined number of consecutive identical codes from first data for transmission to generate a bit inversion instruction signal, wherein the predetermined number is not greater than a specified number of consecutive identical codes in the data transmission system;
a data inversion section for inversing at least one bit of the first data when the bit inversion instruction signal is generated; and
a transmitter for transmitting the second data to the receiving-side communication device, and
the receiving-side communication device comprises:
a receiver for receiving the second data from the sending-side communication device; and
a clock recovery section for recovering a clock from the second data, wherein immunity against consecutive identical codes of the clock recovery section is not greater than the specified number of consecutive identical codes in the data transmission system.

14. The data transmission system according to claim 13, wherein the sending-side communication device further comprises a scrambling section for scrambling transmission data to generate the first data.

15. The data transmission system according to claim 14, wherein the sending-side communication device further comprises an encoder for encoding original transmission data according to error-correction coding to generate the transmission data.

16. The data transmission system according to claim 13, wherein the data inversion section inverts each bit of one byte of the first data.

17. The data transmission system according to claim 13, wherein the specified number is immunity against consecutive identical codes required of clock recovery at the receiving-side communication device.

18. The data transmission system according to claim 13, wherein the predetermined number is determined by dividing the specified number by a desired integer greater than one.
